(19) United States
(12) Patent Application Publication
(10) Pub. No.: US 2013/0330125 A1
(43) Pub. Date: Dec. 12, 2013

(54) CONNECTOR FITTING JIG AND LOW INSERTION FORCE CONNECTOR

(71) Applicants: Hiroshi Aoki, Aichi (JP); Osamu Oshita, Aichi (JP)

(72) Inventors: Hiroshi Aoki, Aichi (JP); Osamu Oshita, Aichi (JP)

(73) Assignee: YAZAKI CORPORATION, Tokyo (JP)

(21) Appl. No.: 13/985,783

(22) PCT Filed: Mar. 1, 2012
(86) PCT No.: PCT/JP2012/055239

§ 371 Date: Aug. 15, 2013

(30) Foreign Application Priority Data
Mar. 1, 2011 (JP) 2011-044364

(51) Int. Cl. F16B 21/09

(52) U.S. Cl. CPC F16B 21/09
USPC 403/356; 29/244

(57) ABSTRACT

A connector fitting jig for attaching and detaching a first housing and a second housing to and from each other by a low insertion and separation force, includes a cylindrical-shaped jig body, an inner cylinder member and a screw shaft. The inner cylinder member is inserted in the jig body and is held to be relatively movable only in an axial direction. The screw shaft is screwed with a threaded portion formed on an inner cylinder inner peripheral surface of the inner cylinder member, and is held to be rotatable relative to a body other end of the jig body, but not to be relatively movable in the axial direction.

### TECHNICAL FIELD

The present invention relates a connector fitting jig and a low insertion force connector, in which fitting of the connector can be performed by a low insertion force.

### BACKGROUND ART

As a low insertion force connector, in which fitting of the connector can be performed by a low insertion force, a low insertion force connector disclosed in PTL1 is known. As shown in FIG. 10, a low insertion force connector 501 includes a male connector 503, a female connector 505, and a rotary shaft 507. The male connector 503 has a pair of left and right flexible arms 513 protruding toward a connector fitting direction from an outlet of a shaft hole 509 provided to extend through a housing, and a pair of front and rear dislodging prevention protrusions 515 provided in a direction perpendicular to the flexible arms 513. The flexible arms 513 have, on the middle parts thereof, narrowed portions 533 formed to define an opposing width narrower than an inner diameter of the shaft hole 509, and distal ends thereof are respectively provided with an inward catching claw 511. The female connector 505 is successively provided with temporary engaging holes 517 and main engaging holes 519 for the catching claws 511 of the flexible arms 513 in the connector fitting direction, and also provided with pin-shaped screw engaging protrusions 521 on an extension line of the shaft hole 509. The rotary shaft 507 has screw thread portions 523 provided on a distal end of a small diameter portion 525 thereof for the pin-shaped screw engaging protrusions 521. Also, the rotary shaft 507 has an annular portion 527 and an annular groove 529 formed continuously to the small diameter portion 525. The annular portion 527 has inserting grooves 531 for the dislodging prevention protrusions 515. The annular groove 529 is communicated with the inserting grooves 531 and allows the dislodging prevention protrusions 515 and the narrowed portions 533 to be successively engaged thereto.

The low insertion force connector 501 as described is configured such that, after the male connector 503 and the female connector 505 are temporarily engaged to each other, a shaft distal end of the rotary shaft 507 is inserted through the shaft hole 509 of the male connector 503 and the dislodging prevention protrusions 515 are inserted through the inserting grooves 531. Then, the narrowed portions 533 of the flexible arms 513 are engaged into the annular groove 529. The catching claws 511 of the flexible arms 513 are engaged into the temporary engaging holes 507 of the female connector 505, thereby performing positioning of the connectors to each other.

Subsequently, the shaft distal end of the rotary shaft 507 is pressed in so that the narrowed portions 533 of the flexible arms 513 are outwardly pushed and spread out, thereby releasing the temporary engagement of the caching claws 511. The dislodging prevention protrusions 515 of the male connector 503 are engaged into the annular grooves 529 of the rotary shaft 507 to fix the small diameter portion 525 in an axial direction thereof. The pin-shaped screw engaging protrusions 521 of the female connector 505 are positioned on the small diameter portion 525 of the rotary shaft 507.

Also, a handle 535 is used to rotate the rotary shaft 507 by a half turn, and thus the pin-shaped screw engaging protrusions 521 are pulled up along the screw thread portions 523. The pin-shaped screw engaging protrusions 521 are positioned in an inserting notch of the screw thread portions 523 rotated by a half turn. The dislodging prevention protrusions 515 of the male connector 503 are positioned in the inserting grooves 531 of the annular portion 527, and the flexible arms 513 of the male connector 503 are positioned such that the caching claws 511 oppose the main engaging holes 519 of the female connector 505 in a spread-out state.

Finally, the small diameter portion 525 of the rotary shaft 507 is removed from the male connector 503 and the female connector 505. As a result, the catching claws 511 are engaged into the main engaging holes 519 of the female connector 505, thereby locking the male connector 503 and the female connector 505 to each other.

### CITATION LIST

### Patent Literature

PTL1: Japanese Patent No. 2613998

### SUMMARY OF INVENTION

### Technical Problem

However, in the low insertion force connector 501 as described above, the male connector 503 has to be provided with the flexible arms 513, the caching claws 511, the dislodging prevention protrusions 515 and the narrowed portions 533, and also the female connector 505 has to be provided with the temporary engaging holes 517, the main engaging holes 519 and the pin-shaped screw engaging protrusions 521. As a result, there are many special-shaped portions, which are difficult to be integrally formed with each other, and thus the housing structure is complicated, thereby causing an increase in size thereof. Further, because a lead angle of the screw thread portions 523 adapted to be engaged with the pin-shaped screw engaging protrusions 521 cannot be reduced in a limited space, it is impossible for an actuation force to be sufficiently small.

The present invention has been made keeping in mind the above problems, and an object of the invention is to provide a connector fitting jig and a low insertion force connector, in which the connector can be fitted or separated by a small actuation force, without providing a complex housing structure.

### Solution to Problem

The above object of the present invention is achieved by the following configurations (1) to (5).

(1) A connector fitting jig for attaching and detaching a first housing and a second housing to and from each other by a low insertion and separation force, including: a cylindrical-shaped jig body including a body engagement portion provided on a body one end thereof, the body engagement portion being adapted to be engaged to a first engagement portion formed in the first housing; an inner cylinder member being inserted in the jig body so that an inner cylinder engagement portion provided on an inner cylinder one end thereof protrudes from an opening of the body one end, and thus being held to be relatively movable only in an axial direction, the inner cylinder engagement portion being adapted to be engaged to a second engagement portion formed in the second housing; and a screw shaft being screwed with a threaded portion formed on an inner cylinder inner peripheral surface of the inner cylinder member, and being held to be rotatable relative to a body other end of the jig body, but not to be relatively movable in the axial direction; wherein the first housing and the second housing are moved relative to each other in a connector fitting direction, by rotating the screw shaft relative to the jig body to move the inner cylinder member relative to the jig body in the axial direction.

(2) The connector fitting jig according to (1), wherein a rotating prevention mechanism is provided between a body inner peripheral surface of the jig body formed in a cylindrical shape and an inner cylinder outer peripheral surface of the inner cylinder member, and the rotation prevention mechanism includes a rib extending along the axial direction and a rib groove allowing the rib to be fitted therein.

(3) The connector fitting jig according to (2), wherein the body engagement portion is formed by an annular-shaped body flange protruding from a body outer peripheral surface, and the inner cylinder engagement portion is formed by an annular-shaped inner cylinder flange protruding from the inner cylinder outer peripheral surface.

(4) A low insertion force connector having a first housing and a second housing adapted to be attached to and detached from each other by a low insertion and separation force, including: a through-shaft protruding on a fitting surface side of the first housing and passing through a shaft hole provided to extend through the second housing in a connector fitting direction; a first engagement portion provided on a through-distal end portion of the through- shaft; and a second engagement portion provided on an outer surface of the second housing and located more toward a centerline of the through-shaft than the first engagement portion, the shaft hole being opened in the outer surface; wherein the first housing and the second housing are moved relative to each other in the connector fitting direction, by moving the first engagement portion and the second engagement portion relative to each other in the connector fitting direction.

(5) The low insertion force connector according to (4), wherein the first engagement portion has a first engagement edge defining a first engagement space allowing the second engagement portion to be engaged therein, and the second engagement portion has a second engagement edge defining a second engagement space between the second engagement edge and the outer surface of the second housing.

According to the connector fitting jig of the above configuration (1), the inner cylinder member is screw-fed relative to the jig body in the axial direction by rotating the screw shaft relative to the jig body. As a result, the first housing, in which the body engagement portion of the jig body is engaged in the first engagement portion thereof, and the second housing, in which the inner cylinder engagement portion of the inner cylinder member is engaged to the second engagement portion thereof, can be moved relative to each other in the connector fitting direction. Therefore, the first housing and the second housing can be fitted to and separated from each other by a small rotational force of the screw shaft.

In addition, the first engagement portion of the first housing and the second engagement portion of the second housing have simple shapes in which each is respectively caught to the body engagement portion of the jig body and the inner cylinder engagement portion of the inner cylinder member along the fitting direction, and as a result, the first housing and the second housing are not required to have a complex housing structure.

According to the connector fitting jig of the above configuration (2), the jig body can have a cylindrical shape, which can be easily formed, and in addition, the inner cylinder member inserted in the jig body can be held to be relatively moved only in the axial direction.

According to the connector fitting jig of the above configuration (3), by forming the body engagement portion and the inner cylinder engagement portion by the body flange and the inner cylinder flange having an annular shape, directionality when the body engagement portion and the inner cylinder engagement portion are respectively engaged into the first engagement portion of the first housing and the second engagement portion of the second housing can be eliminated, thereby improving workability of fitting the connector.

According to the low insertion force connector of the above configuration (4), by moving the first engagement portion and the second engagement portion relative to each other in the connector fitting direction, using the connector fitting jig, for example, of the above configuration (1), the first housing and the second housing can be easily fitted to and separated from each other.

In addition, there is no need to form a complex housing structure as in the low insertion force connector according to the related art.

According to the low insertion force connector of the above configuration (5), by using the connector fitting jig, for example, of the above configuration (1), which can make the corresponding first and second engagement portion be engaged to the first engagement edge or the second engagement edge, the first engagement portion can be pulled-up using as a lower depressing seat the second engagement edge, or the second engagement portion can be pulled-up using as an upper depressing seat the first engagement edge, and as a result, the first housing and the second housing can be easily moved to each other in the connector fitting direction.

In the foregoing, the present invention has been briefly described. Also, details of the present invention will be further apparent, when modes (hereinafter, referred to as “embodiments”) for embodying the invention as described below are thoroughly read with reference to the accompanying drawings.

### BRIEF DESCRIPTION OF DRAWINGS

FIG. 1 is a side view of a connector fitting jig according to a first embodiment of the present invention.

FIG. 2 is a perspective view of an inner cylinder member and a screw shaft of the connector fitting jig shown in FIG. 1.

FIG. 3 is a schematically exploded perspective view of a jig body, the inner cylinder member and the screw shaft shown in FIG. 1.

FIG. 4 is an exploded perspective view of a low insertion force connector according to an embodiment of the present invention.

FIG. 5A is a partially cut-away side view of the low insertion force connector before fitting, and FIG. 5B is a partially cut-away side view of the low insertion force connector after fitting.

FIG. 6 is an enlarged longitudinal sectional view of a main part showing an arrangement between a body flange and an inner cylinder flange upon fitting of the connector.

FIG. 7 is a perspective view of the whole part showing an arrangement between the body flange and the inner cylinder flange upon separating of the connector.

FIG. 8 is a partially broken, enlarged side view showing a variant of an axial movement restriction member shown in FIG. 1.

FIG. 9 is a perspective view of a connector fitting jig according to a second embodiment of the present invention.

FIG. 10 is an exploded longitudinal sectional view of a low insertion force connector according to the related art.

### Description of Embodiments

Embodiments according to the present invention will be now described in detail with reference to the accompanying drawings.

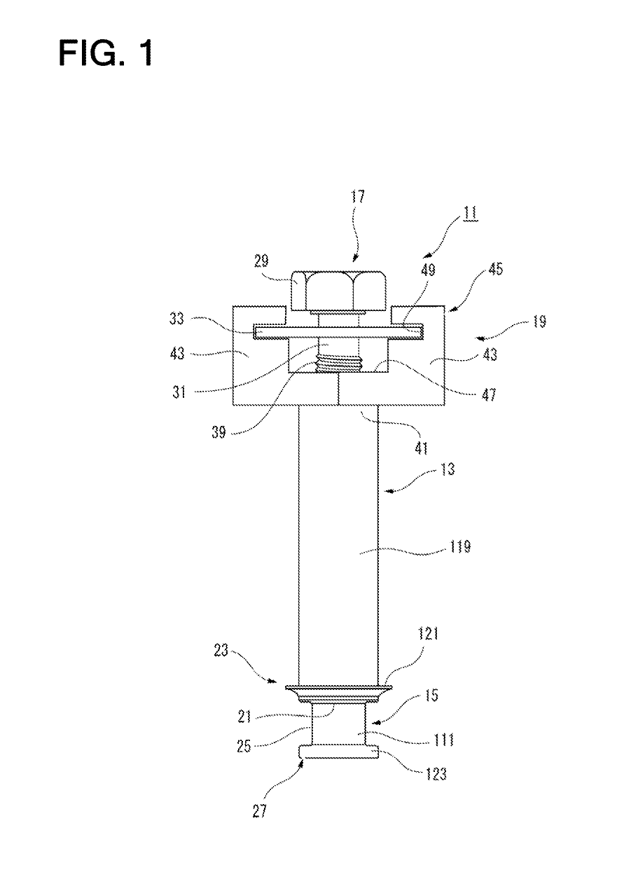

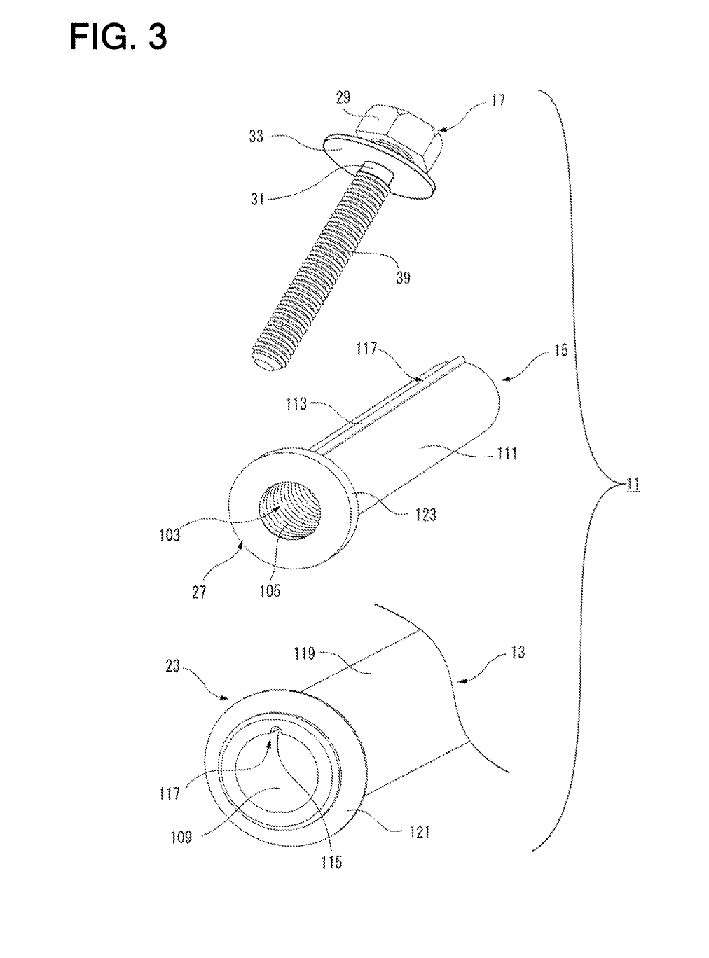

As shown in FIGS. 1 to 3, a connector fitting jig 11 according to a first embodiment of the present invention, if broadly classified, includes a jig body 13, an inner cylinder member 15 and a screw shaft 17.

The jig body 13 is formed in a generally cylindrical shape, and is provided with a body engagement portion 23 on a body one end 21 at a lower side thereof and also with an axial movement restriction member 19 on a body other end 41 at an upper side thereof

The inner cylinder member 15 is inserted in the jig body 13 so that an inner cylinder engagement portion 27 provided on an inner cylinder one end 25 at a lower side thereof protrudes from an opening of the body one end 21 of the jig body 13, and thus is held to be relatively movable only in an axial direction. The inner cylinder engagement portion 27 is engaged to a second engagement portion 87 formed in a female connector housing 63 as described below.

A rotating prevention mechanism 117 constituted of a rib 113 extending along the axial direction and a rib groove 115 allowing the rib 113 to be fitted therein is provided between a body inner peripheral surface 109 of the jig body 13 and an inner cylinder outer peripheral surface 111 of the inner cylinder member 15. Due to the rib 113 and the rib groove 115, the connector fitting jig 11 is configured such that the jig body 13 can have a cylindrical shape, which can be easily formed, and in addition, the inner cylinder member 15 inserted in the jig body can be held to be relatively moved only in the axial direction.

Further, the body engagement portion 23 is formed by an annular-shaped body flange 121 protruding from a body outer peripheral surface 119. Also, the inner cylinder engagement portion 27 is formed by an annular-shaped inner cylinder flange 123 protruding from the inner cylinder outer peripheral surface 111. By forming the body engagement portion 23 and the inner cylinder engagement portion 27 by the body flange 121 and the inner cylinder flange 123 having such an annular shape, directionality when the body engagement portion 23 and the inner cylinder engagement portion 27 are respectively engaged into a first engagement portion 79 of a male connector housing 59 and the second engagement portion 87 of the female connector housing 63 as described below can be eliminated. Therefore, workability of fitting the connector can be improved.

The screw shaft 17 has a hexagonal head portion 29 and a flange portion 33 radially outwardly protruding on a neck portion 31 thereof. The flange portion 33 may be provided by fixing a separate member, and also may be formed by cutting a large diameter portion formed as a forged member. In the screw shaft 17, the head portion 29 is rotated by a tool, such as a spanner. A portion below the neck portion 31 is entirely formed as a male screw portion 39.

In addition, the screw shaft 17 is screwed with a threaded portion 105 formed on an inner cylinder inner peripheral surface 103 of the inner cylinder member 15. Further, due to the axial movement restriction member 19, the screw shaft 17 is held to be rotatable relative to the body other end 41 of the jig body 13, but not to be relatively movable in the axial direction.

The axial movement restriction member 19 has a block body 43 adapted to be fixed on the body other end 41 of the jig body 13. The block body 43 is constituted of a pair of L-shaped blocks 45 radially inwardly abutted and fixed to each other on the body other end 41. Thus, a block recess 47 is formed in the middle portion of the block body 43, and in each of the opposing walls of the block recess 47, a restriction groove 49 is formed to sandwich an outer peripheral portion of the flange portion 33 from upper and lower sides thereof. In addition, the head portion 29 of the screw shaft 17 rotatably protrudes from an upper surface of the block body 43.

The axial movement restriction member 19 fixed on the body other end 41 restricts an axial movement of the jig body 13 and the screw shaft 17 by rotatably sandwiching the flange portion 33. Therefore, the axial movement restriction member 19 can hold the screw shaft 17 to be rotatable relative to the body other end 41 of the jig body 13, but not to be relatively movable in the axial direction.

By having the configuration as described above, the connector fitting jig 11 can make the male connector housing 59 and the female connector housing 63 be moved relative to each other in a connector fitting direction, by rotating the screw shaft 17 relative to the jig body 13 to move the inner cylinder member 15 relative to the jig body 13 in the axial direction.

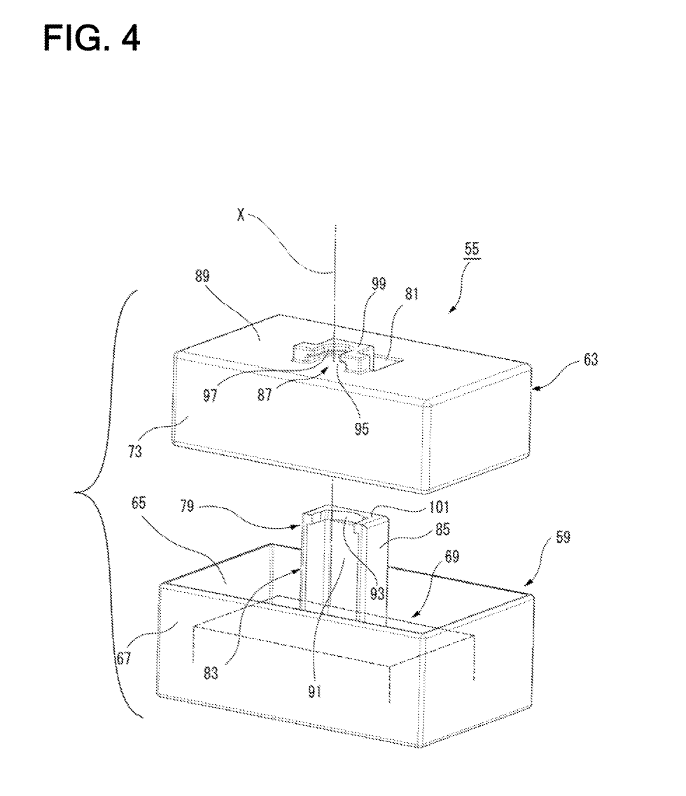

As shown in FIG. 4, a low insertion force connector 55 according to the present embodiment includes the male connector housing 59 as a first housing, and the female connector housing 63 as a second housing.

The male connector housing 59 has a rectangular hood portion 67 opened on an upper surface thereof to provide a fitting open 65, and a male connector portion 69 having a shape substantially similar to the hood portion 67 is provided to protrude on the inside of the hood portion 67. A plurality of connection terminals, not shown, is housed in the interior of the male connector portion 69.

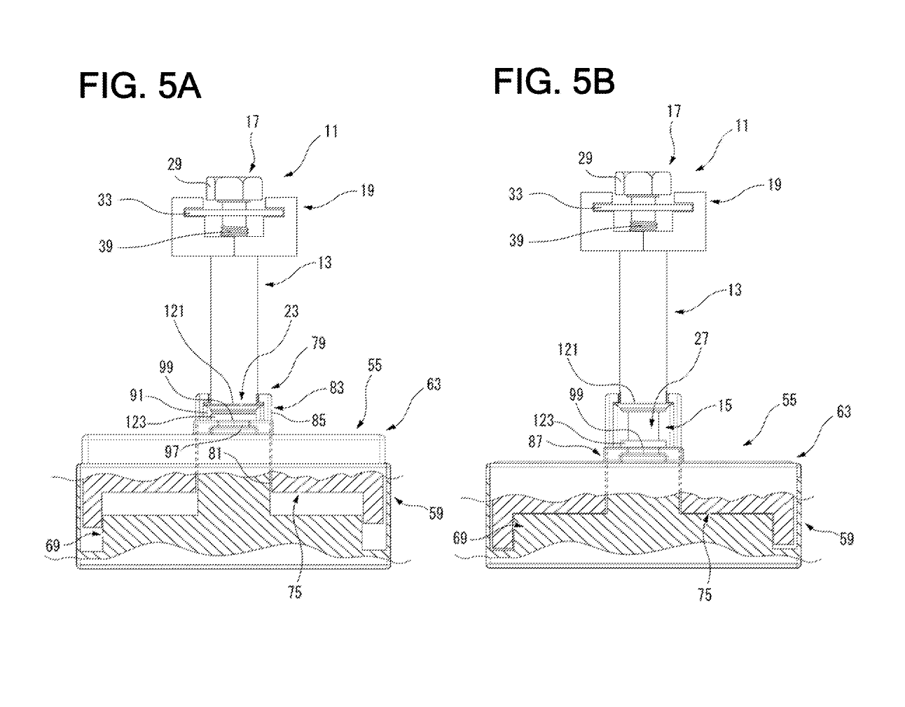

The female connector housing 63 is fitted by inserting a housing peripheral wall 73 on a lower side thereof into the hood portion 67 of the male connector housing 59. On a lower surface of the housing peripheral wall 73, a female connector portion 75 (see FIG. 5) adapted to receive the male connector portion 69 is provided. A plurality of connection terminals, not shown, is housed in the interior of the female connector portion 75. The male connector housing 59 and the female connector housing 63 are configured such that, when the housing peripheral wall 73 of the female connector housing 63 enters the hood portion 67 of the male connector housing 59, the male connector portion 69 is fitted in the female connector portion 75, thereby connecting connection terminals to each other.

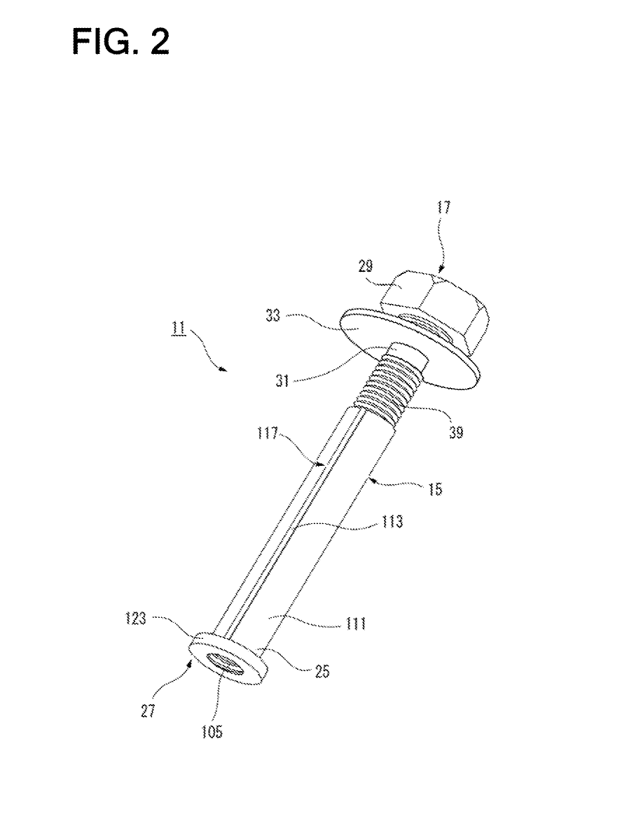

The male connector housing 59 according to the present embodiment is provided with a through-shaft 83 protruded toward a fitting direction (an upward direction in FIG. 2) at the substantially center of the male connector portion 69, which corresponds to a fitting surface side. Although the through-shaft 83 according to the present embodiment is formed in a generally U-shaped cross sectional shape, the present invention is not limited to this configuration. When the male connector housing 59 and the female housing 63 are fitted to each other, the through-shaft 83 is passed through a shaft hole 81 provided to extend through the female connector housing 63 in the connecter fitting direction. A through-distal end portion 85 of the through-shaft 83 is provided with the first engagement portion 79 adapted to be engaged with the body engagement portion 23 of the connector fitting jig 11.

On an outer surface 89 of the female connector housing 63 in which the shaft hole 81 having a generally U-shaped cross sectional shape is opened, the second engagement portion 87 located more toward a centerline X of the through-shaft 83 than the first engagement portion 79 is provided to be adjacent to the shaft hole 81.

The first engagement portion 79 has a first engagement edge 93 defining a first engagement space 91 inside which the second engagement portion 87 is engaged. Meanwhile, the second engagement portion 87 has a second engagement edge 97 defining a second engagement space 95 between itself and the outer surface 89 of the female connector housing 63.

The first engagement edge 93 is corresponded and engaged with the body engagement portion 23 of the jig body 13, and the second engagement edge 93 is corresponded and engaged with the inner cylinder engagement portion 27 of the inner cylinder member 15.

In the low insertion force connector 55 as described above, by using the connector fitting jig 11, the first engagement portion 79 can be pulled-up using as a lower depressing seat 99 the second engagement edge 97, or the second engagement portion 87 can be pulled-up using as an upper depressing seat 101 the first engagement edge 93. As a result, the male connector housing 59 and the female connector housing 63 can be easily moved to each other in the connector fitting direction.

Next, operations of the connector fitting jig 11 and the low insertion force connector 55 having the foregoing configurations will be described.

To fit the low insertion force connector 55 using the connector fitting jig 55, as shown in FIG. 5A, the through-shaft 83 provided to protrude on the male connector housing 59 is firstly passed through the shaft hole 81 of the female connector hosing 63.

Subsequently in a state where the first engagement portion 79 of the through-distal end portion 85 is protruded from the shaft hole 81, the body flange 121 is inserted into the first engagement space 91. Also, the inner cylinder flange 123 of the inner cylinder member 15 is contacted to the lower depressing seat 99 of the second engagement edge 97 from the upper side thereof.

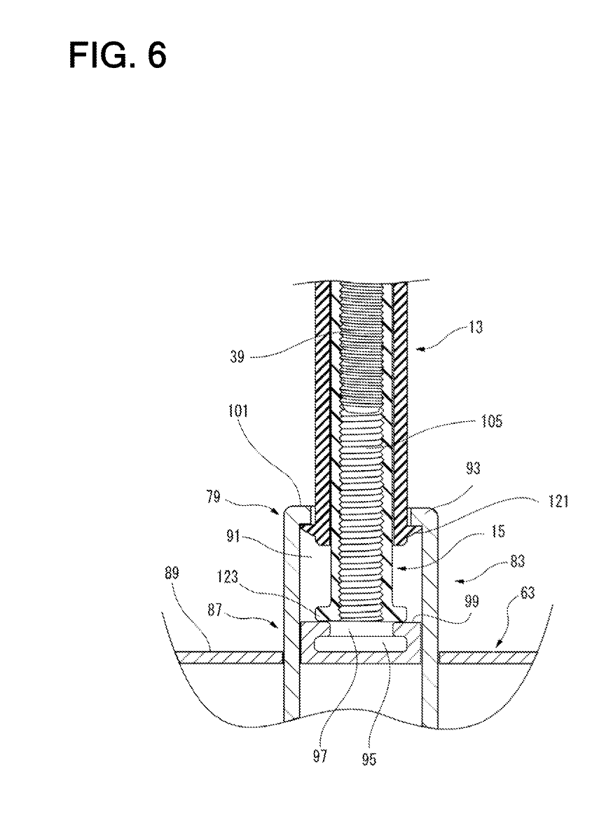

As shown in FIG. 5B, when the screw shaft 17 is rotated in a counterclockwise direction, the inner cylinder member 15 is protruded downward from the jig body 13, so that the inner cylinder flange 123 is pressed against the lower depressing seat 99. Therefore, as shown in FIG. 6, the body flange 121 pulls up the first engagement portion 79 via the first engagement edge 93 and thus the through-shaft 83 provided with the first engagement portion 79 is pulled up, thereby fitting the male connector housing 59 and the female connector housing 63 to each other.

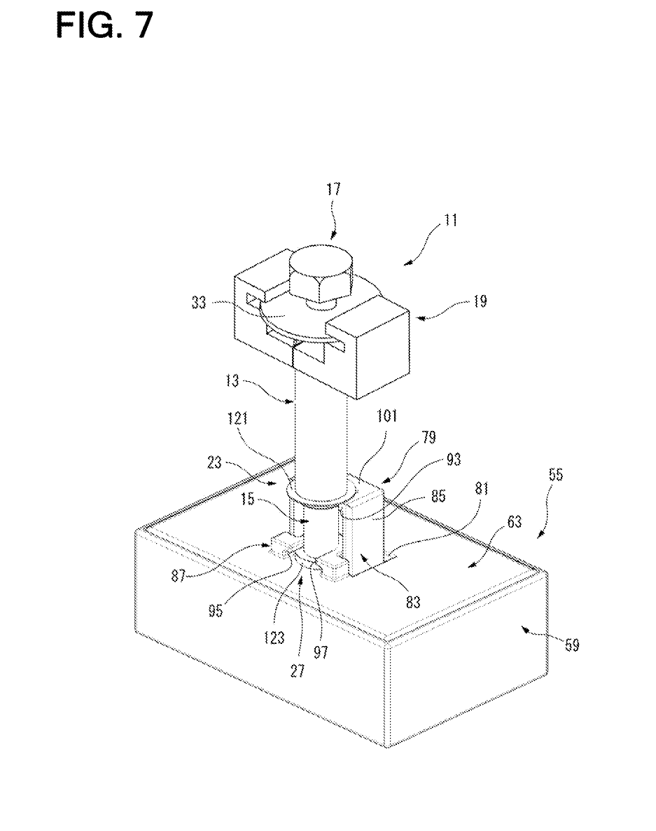

In addition, to separate the male connector housing 59 and the female connector housing 63 fitted to each other, as shown in FIG. 7, the first engagement edge 93 in the first engagement portion 79 of the through-distal end portion 85 protruded from the shaft hole 81 is used as the upper depressing seat 101. The body flange 121 is contacted to the upper depressing seat 101 from the upper side thereof Meanwhile, the inner cylinder flange 123 of the inner cylinder member 15 is inserted into the second engagement space 95 in the second engagement portion 87 of the female connector housing 63.

Namely, the first engagement portion 79 and the second engagement portion 93 become a state where the first engagement edge 93 and the second engagement edge 97 are sandwiched from upper and lower sides thereof by the body flange 121 and the inner cylinder flange 123. In this state, when the screw shaft 17 is rotated in a clockwise direction, the inner cylinder member 15 is pulled into the jig body 13. Therefore, the through-shaft 83 is pushed out, thereby separating the male connector housing 59 and the female connector housing 63 from each other.

In this way, according to the connector fitting jig 11 of the present embodiment, the inner cylinder member 15 is screw-fed relative to the jig body 13 in the axial direction, by rotating the screw shaft 17 relative to the jig body 13. In addition, by moving the first engagement portion 79 of the male connector housing 59 and the second engagement portion 87 of the female connector housing 63 relative to each other along the connector fitting direction, the male connector housing 59 and the female connector housing 63 can be fitted to and separated from each other by a small rotational force.

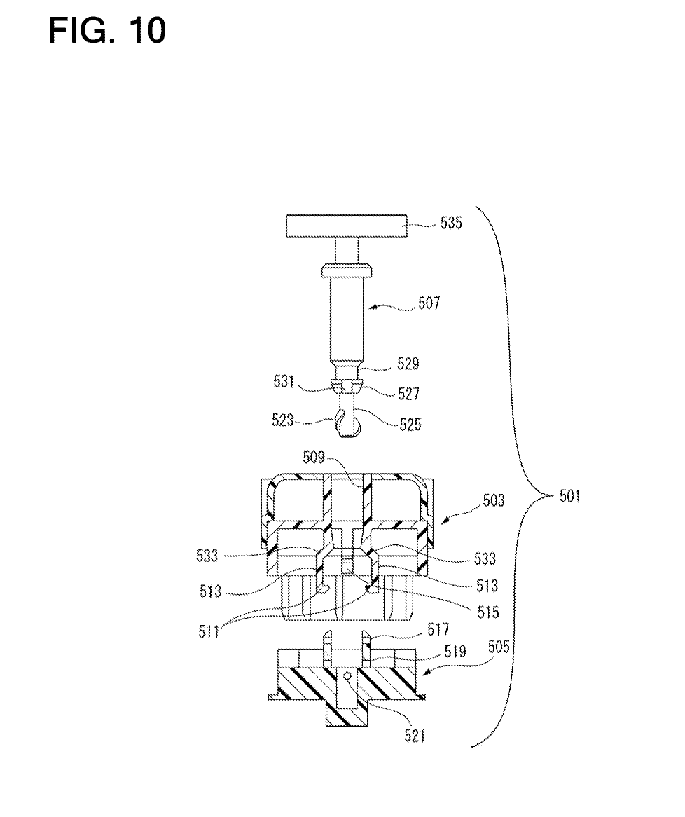

Further, according to the low insertion force connector 55 of the present embodiment, the first engagement portion 79 of the male connector housing 59 and the second engagement portion 87 of the female connector housing 63 have simple shapes in which each is respectively caught to the body engagement portion 23 of the jig body 13 and the inner cylinder engagement portion 27 of the inner cylinder member 15 along the fitting direction. For this reason, the low insertion force connector 55 is not required to form a complex housing structure as in the low insertion force connector 501 according to the related art as shown in FIG. 10.

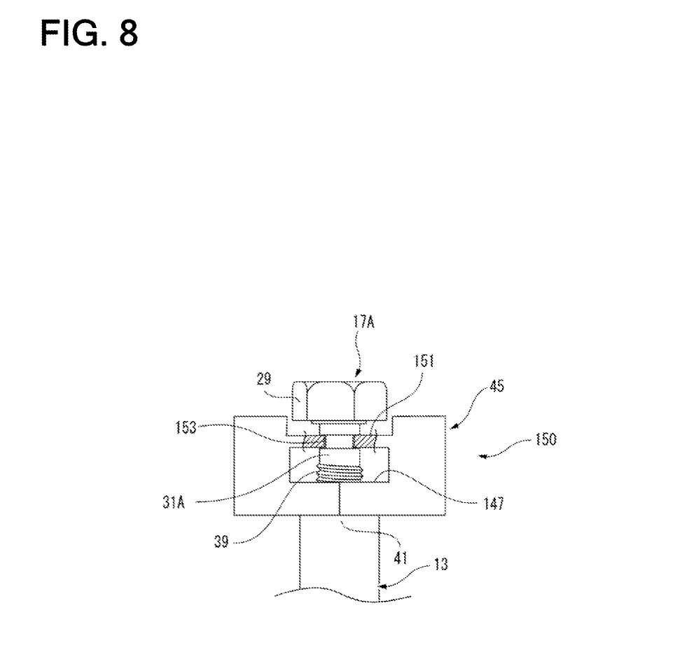

FIG. 8 is a partially broken, enlarged side view showing a variant of the axial movement restriction member 19 as described above.

As shown in FIG. 8, an axial movement restriction member 150 may have a structure in which flange portions 151 are provided on opposing walls of a block recess 147 and the flange portions 151 are engaged in a neck engagement groove 153 formed in a neck portion 31A of a screw shaft 17A. According to this variant, there is no need to provide the flange portion 33 to the screw shaft 17A, and thus the screw shaft 17A can be easily formed by machining a commercially available product.

Next, a connector fitting jig 125 according to a second embodiment of the present invention will be described. Meanwhile, the identical reference numerals are designated to components generally similar to those of the connector fitting jig 11 of the first embodiment, and accordingly the detailed description thereof will be omitted.

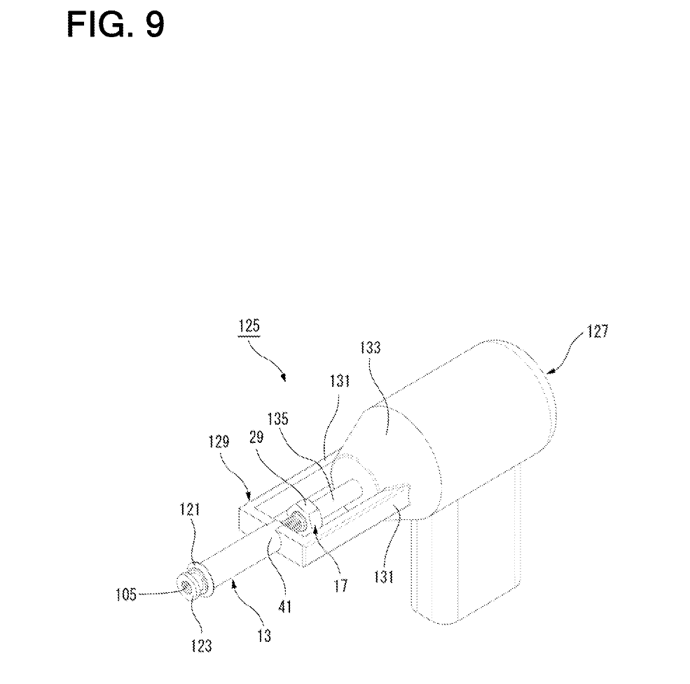

As shown in FIG. 9, the connector fitting jig 125 according to the second embodiment includes a jig body 13 and a rotation driving unit 127, such as a torque wrench, integrally formed with each other.

A U-shaped bracket 129 is fixed on a body other end 41 of the jig body 13, and both distal ends 131 of the U-shaped bracket 129 are fixed on a head cover 133 of the rotation driving unit 127.

The rotation driving unit 127 has a rotation driving shaft 135 protruding on the center of the head cover 133, and the rotation driving shaft 135 is connected to a head portion 29 of a screw shaft 17 so as not to allow a relative rotation. The rotation driving unit 127 is configured such that the rotation driving shaft 135 can be rotated in forward and reverse directions by an electric motor or an actuator, not shown.

According to the connector fitting jig 125, the screw shaft 17 is rotated by rotating the rotation driving shaft 135 of the rotation driving unit 127, so that a body flange 121 and an inner cylinder flange 123 are moved in a direction closer to or away from each other. Therefore, similarly to the connector fitting jig 11 according to the first embodiment, if the body flange 121 and the inner cylinder flange 123, as shown in FIG. 6, are inserted between the first engagement edge 93 and the second engagement edge 97, the connector fitting between the male connector housing 59 and the female connector housing 63 can be more easily achieved, without being manually performed.

In addition, as shown in FIG. 7, if the first engagement edge 93 and the second engagement edge 97 are sandwiched from upper and lower sides thereof by the body flange 121 and the inner cylinder flange 123, separating the male connector housing 59 and the female connector housing 63 from each other can be more easily achieved, without being manually performed.

As described above, according to the connector fitting jigs 11 and 125 and the low insertion force connector 55 of the forgoing embodiments, the male connector housing 59 and the female connector housing 63 can be fitted to or separated from each other by a small actuation force, without providing the male connector housing 59 and the female connector housing 63 with a complex housing structure.

Meanwhile, components, such as the jig body, the body engagement portion, the inner cylinder member, the inner cylinder engagement portion, the screw shaft, the first and second housings, the through-shaft, the shaft hole, the first and second engagement portions, the first and second engagement edges, and the first and second engagement spaces according to the connector fitting jig and the low insertion force connector of the present invention are not limited to the configurations of the foregoing embodiments, but can employ various configurations based on the spirit of the invention. In addition, material, shape, dimension, number, installation position and the like of each of the components of the foregoing embodiments are not limited but arbitrary as long as the present invention can be achieved.

For example, although, in the foregoing embodiment, the male connector housing 59 is described as the first housing and the female connector housing 63 is described as the second housing, the female connector housing may be the first housing and the male connector housing may be the second housing.

This application is based on Japanese Patent Application No. 2011-044364 filed on Mar. 1, 2011, the entire contents of which are incorporated herein by reference.

### INDUSTRIAL APPLICABILITY

According to the connector fitting jig and the low insertion force connector of the present invention, the connector can be fitted or separated by a small actuation force, without providing a complex housing structure.

### REFERENCE SIGNS LIST

11 Connector fitting jig
13 Jig body
15 Inner cylinder member
17 Screw shaft
21 Body one end
23 Body engagement portion
25 Inner cylinder one end
27 Inner cylinder engagement portion
41 Body other end
55 Low insertion force connector
59 Male connector housing (First housing)
66 Female connector housing (Second housing)
79 First engagement portion
81 Shaft hole
83 Through-shaft
85 Through-distal end portion
87 Second engagement portion
89 Outer surface
91 First engagement space
93 First engagement edge
95 Second engagement space
97 Second engagement edge
103 Inner cylinder inner peripheral surface
105 Threaded portion
109 Body inner peripheral surface
111 Inner cylinder outer peripheral surface
113 Rib
115 Rib groove
117 Rotating prevention mechanism
119 Body outer peripheral surface
121 Body flange
123 Inner cylinder flange

1. A connector fitting jig for attaching and detaching a first housing and a second housing to and from each other by a low insertion and separation force, comprising:
a cylindrical-shaped jig body that includes a body engagement portion provided on a body one end thereof, the body engagement portion being adapted to be engaged to a first engagement portion formed in the first housing;
an inner cylinder member that is inserted in the jig body so that an inner cylinder engagement portion provided on an inner cylinder one end thereof protrudes from an opening of the body one end, and thus is held to be relatively movable only in an axial direction, the inner cylinder engagement portion being adapted to be engaged to a second engagement portion formed in the second housing; and
a screw shaft that is screwed with a threaded portion formed on an inner cylinder inner peripheral surface of the inner cylinder member, and is held to be rotatable relative to a body other end of the jig body, but not to be relatively movable in the axial direction;
wherein the first housing and the second housing are moved relative to each other in a connector fitting direction, by rotating the screw shaft relative to the jig body to move the inner cylinder member relative to the jig body in the axial direction.

2. The connector fitting jig according to claim 1, wherein a rotating prevention mechanism is provided between a body inner peripheral surface of the jig body formed in a cylindrical shape and an inner cylinder outer peripheral surface of the inner cylinder member, and the rotation prevention mechanism includes a rib extending along the axial direction and a rib groove allowing the rib to be fitted therein.

3. A low insertion force connector having a first housing and a second housing adapted to be attached to and detached from each other by a low insertion and separation force, comprising:
a through-shaft that protrudes on a fitting surface side of the first housing and passes through a shaft hole provided to extend through the second housing in a connector fitting direction;
a first engagement portion that is provided on a through-distal end portion of the through-shaft; and
a second engagement portion that is provided on an outer surface of the second housing and is located more toward a centerline of the through-shaft than the first engagement portion, the shaft hole being opened in the outer surface of the second housing;
wherein the first housing and the second housing are moved relative to each other in the connector fitting direction, by moving the first engagement portion and the second engagement portion relative to each other in the connector fitting direction.

4. The low insertion force connector according to claim 3, wherein the first engagement portion has a first engagement edge defining a first engagement space allowing the second engagement portion to be engaged therein, and the second engagement portion has a second engagement edge defining a second engagement space between the second engagement edge and the outer surface of the second housing.
